(19) United States
(12) Patent Application Publication
(10) Pub. No.: US 2022/0037080 A1
(43) Pub. Date: Feb. 3, 2022

(54) SHIELDING ARRANGEMENTS FOR TRANSFORMER STRUCTURES

(71) Applicant: Cree Fayetteville, Inc., Fayetteville, AR (US)

(72) Inventors: Dmitri Kovalevskii, Fayetteville, AR (US); Tyler Adamson, Farmington, AR (US)

(21) Appl. No.: 16/942,082

(22) Filed: Jul. 29, 2020

(51) Int. Cl. H01F 27/28; H01F 27/32; H01F 27/24; H02M 5/10; H01F 27/36

(52) U.S. Cl. CPC H01F 27/2885; H01F 27/323; H01F 27/36; H02M 5/10; H01F 27/24

(57) ABSTRACT

Shielding arrangements for transformer structures capable for operation in high frequency and high power density applications are disclosed. Electric shields may be incorporated within transformers to shield and/or redirect high strength electric fields away from areas of insulation material that may be prone to failure mechanisms. Such electric shields may be positioned between primary and secondary windings in order to be coupled with electric potentials of the windings. The electric shield may comprise a laminate structure that includes one or more metal layers and one or more dielectric layers, for example a printed circuit board. By positioning the electric shields in this manner, high electric fields associated with solid state transformer applications may be concentrated within planes of the electric shields and diverted away from potential problem areas, for example areas that are close to the windings where voids in the insulation material may otherwise promote failure mechanisms.

### FIELD OF THE DISCLOSURE

The present disclosure relates to shielding arrangements for transformer structures, and more particularly to shielding arrangements in transformer structures for high frequency and high power density applications.

### BACKGROUND

Semiconductor devices such as transistors and diodes are ubiquitous in modern electronic devices and systems. In particular, wide bandgap semiconductor material systems such as gallium arsenide (GaAs), gallium nitride (GaN), and silicon carbide (SiC) are being increasingly utilized in electronic devices and systems to push the boundaries of device performance in areas such as switching speed, power handling capability, efficiency, and thermal conductivity. Examples include individual devices such as metal-oxide-semiconductor field-effect transistors (MOSFETs), insulated gate bipolar transistors (IGBTs), Schottky barrier diodes, GaN high electron mobility transistors (HEMTs), and integrated circuits such as monolithic microwave integrated circuits (MMICs) that include one or more individual devices.

Power devices made with SiC provide significant advantages for use in high speed, high power and/or high temperature applications due to the high critical field and wide band gap of SiC. Power conversion and transfer systems, such as those that include medium-voltage transformers for use in electric power distribution systems, are increasingly incorporating SiC power switching devices to realize increased switching frequencies, higher power densities and efficiencies with reduced device complexity. In transformer applications, increased switching frequencies and higher power handling can stress other system components, leading to challenges associated with electric field stress and distribution.

The art continues to seek improved power transfer devices having desirable characteristics such as improved switching frequencies and power densities while overcoming challenges associated with conventional power transfer devices.

### SUMMARY

The present disclosure relates to shielding arrangements for transformer structures, and more particularly to shielding arrangements in transformer structures for high frequency and high power density applications. Electric shields may be incorporated within transformers of solid state transformer devices to shield and/or redirect high strength electric fields away from areas of insulation material that may be prone to failure mechanisms. Such electric shields may be positioned between primary and secondary windings in order to be coupled with electric potentials of the primary and/or secondary windings. The electric shield may comprise a laminate structure that includes one or more metal layers and one or more dielectric layers, for example a printed circuit board. By positioning the electric shields in this manner, high electric fields associated with solid state transformer applications may be concentrated within planes of the electric shields and diverted away from potential problem areas of the insulation material, for example areas close to the windings where voids that cause failure mechanisms in the insulation material may be more common.

In one aspect, a transformer comprises: a primary winding; a secondary winding; an insulation material arranged between the primary winding and the secondary winding; and at least one electric shield positioned at least partially within the insulation material and between the primary winding and the secondary winding. In certain embodiments, the at least one electric shield comprises at least one metal layer and at least one dielectric material, the at least one metal layer residing on the at least one dielectric material or within the at least one dielectric material. The at least one metal layer may comprise a plurality of metal layers, a first metal layer of the plurality of metal layers is on the at least one dielectric material, and a second metal layer of the plurality of metal layers is within the at least one dielectric material. In certain embodiments, the first metal layer is arranged closer to one of the primary winding or the secondary winding than the second metal layer, the first metal layer being arranged to extend a distance that corresponds to at least a longest dimension of the primary winding or the secondary winding, and the second metal layer is arranged to extend a distance that is greater than the first metal layer. In certain embodiments, the at least one electric shield comprises a printed circuit board. The at least one electric shield may comprise a first electric shield that is coupled with an electric potential of the primary winding and a second electric shield that is coupled with an electric potential of the secondary winding. In certain embodiments, the at least one electric shield is completely encapsulated within the insulation material.

The transformer may further comprise a coil former that at least partially defines a shape of at least one of the primary winding and the secondary winding. In certain embodiments, the coil former and the at least one electric shield define the shape of at least one of the primary winding and the secondary winding. In certain embodiments, the coil former forms at least one opening that supports at least a portion of the at least one electric shield. The transformer may further comprise a magnetic core, wherein the insulation material, the primary winding, the secondary winding, and the at least one electric shield form a winding package, the winding package forming a central opening, and a portion of the magnetic core resides within the central opening. In certain embodiments, the primary winding forms a winding turn along a corner of the winding package and the at least one electric shield extends past the winding turn. The transformer may further comprise at least one thermal plate arranged between the winding package and the magnetic core. In certain embodiments, the primary winding is configured as a medium voltage winding and the secondary winding is configured as a low voltage winding. At least one of the primary winding and the secondary winding may comprise multiple-strand wiring or a foil structure. In certain embodiments, the insulation material may comprise a viscosity in a range from 2500 centipoise (cP) to 5000 cP.

In another aspect, a solid state transformer comprises: a first voltage stage; a second voltage state; and an isolation stage arranged between the first voltage stage and the second voltage stage, the isolation stage comprising: a transformer comprising a primary winding, a secondary winding, an insulation material arranged between the primary winding and the secondary winding, and at least one electric shield positioned between the primary winding and the secondary winding. In certain embodiments, the at least one electric shield is encapsulated within the insulation material. In certain embodiments, the at least one electric shield comprises a printed circuit board. At least one of the first voltage stage and the second voltage stage may comprise a wide band gap switching device. In certain embodiments, the wide band gap switching device comprises a silicon carbide switching device. In certain embodiments, the isolation stage comprises a wide band gap switching device, such as a silicon carbide switching device. In certain embodiments, the first voltage stage comprises a medium voltage stage electrically connected to the primary winding, and the second voltage stage comprises a low voltage stage electrically coupled to the secondary winding. In certain embodiments, the solid state transformer is rated for operation up to 485 kilovolt-amperes. In certain embodiments, the insulation material may comprise a viscosity in a range from 2500 cP to 5000 cP.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a functional schematic diagram of a solid state transformer according to aspects disclosed herein.

FIG. 2A is a side cross-sectional view illustrating a winding arrangement for the transformer of FIG. 1 according to aspects of the present disclosure.

FIG. 2B is a side cross-sectional view of the winding arrangement for the transformer of FIG. 2B with an insulation material added to encapsulate the windings.

FIG. 3A is a side view of the transformer of FIG. 2A illustrating an arrangement of a winding package relative to a core.

FIG. 3B is an end view of the transformer of FIG. 3A illustrating an embodiment where core portions are provided with a U-shape, a portion of which is arranged within an opening of the winding package.

FIG. 4A is a cross-sectional view of the transformer of FIG. 3A taken along the sectional line 4A-4A of FIG. 3A.

FIG. 4B is an expanded view of a portion of the winding package of

FIG. 4A with superimposed arrows indicating distribution of an electric field within the winding package during operation.

FIG. 5A is a cross-sectional view of a transformer that is similar to the transformer of FIG. 4A, but where a primary winding comprises a foil structure.

FIG. 5B is an expanded view of a portion of the winding package of FIG. 5A with superimposed dashed arrows indicating distribution of the electric field within the winding package during operation.

FIG. 6A is a cross-sectional view of a transformer that is similar to the transformer of FIG. 4A, and further includes one or more electric shields arranged within the winding package to alter electric field distribution during operation.

FIG. 6B is an expanded view of a portion of the winding package of FIG. 6A with superimposed dashed arrows indicating distribution of the electric field within the winding package during operation.

FIG. 7 is a perspective view of a model of a transformer illustrating an arrangement of electric shields and a coil former relative to one or more cores according to aspects of the present disclosure.

FIG. 8 is an expanded cross-sectional view of a corner of the winding package of FIG. 7 illustrating an arrangement of the primary winding and multiple secondary windings relative to the electric shields.

FIG. 9A is a cross-sectional view of a transformer that is similar to the transformer of FIG. 6A, except the secondary winding is configured with two halves on opposing sides of the primary winding.

FIG. 9B is an expanded view of a portion of the winding package of FIG. 9A.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

Advances in power semiconductor switching devices, for example wide band gap semiconductor switching devices based on silicon carbide (SiC) and gallium nitride (GaN), are enabling improvements in electric power distribution systems. Solid state transformers that incorporate wide band gap semiconductor switching devices may provide improved efficiency with reduced size compared with conventional transformer systems. As used herein, a solid state transformer may include circuitry configured for operation according to various power transfer applications including alternating current (AC) and direct current (DC) configurations, for example AC-to-AC conversions or AC-to-DC-to-DC-to-AC conversions, among others. The solid state transformer additionally includes a transformer having primary and secondary windings positioned between an input and an output to transfer power and provide electrical isolation. For example, in an AC-to-DC-to-DC-to-AC solid state transformer, the transformer having primary and secondary windings may reside in the DC-to-DC converter portion. For an AC-to-AC solid state transformer without a DC-to-DC converter portion, the transformer having primary and secondary windings may reside within the AC-AC converter.

Embodiments of the present disclosure may refer to different operating voltage ranges by the terms low voltage (LV), medium voltage (MV), or high voltage (HV). As used herein LV may refer to voltages of up to 1000 volts (V), MV may refer to voltages in a range from 1000 V to 35 kilovolts (kV), and HV may refer to voltages above 35 kV.

In applications for MV or HV power, corresponding MV and HV transformers typically require an insulation material that is capable of handling high voltages, for example a potting material, to be arranged between the primary and secondary windings and provide encapsulation. Increased switching frequencies and higher power handling associated with solid state transformers can provide high strength electric fields that stress the insulation material, thereby leading to increased dielectric losses, partial discharges and corona events, and even catastrophic device failure. Additionally, it can be difficult to provide the insulation material between the primary and secondary windings without having small material voids that only exacerbate these mechanisms.

The present disclosure relates to shielding arrangements for transformer structures, and more particularly to shielding arrangements in transformer structures for high frequency and high power density applications. According to aspects disclosed herein, electric shields are incorporated within transformers of solid state transformer devices to shield and/or redirect high strength electric fields away from areas of the insulation material that may be prone to failure mechanisms. Such electric shields may be positioned between primary and secondary windings along one or more planes that are connected with electric potentials of the primary and/or secondary windings. For example, the electric shield may comprise a laminate structure that includes one or more metal layers and one or more dielectric layers. In certain aspects, the laminate structure may embody a printed circuit board or a dielectric material that supports a metal layer. Notably, a printed circuit board structure for the electric shield may allow multiple metal layers of the printed circuit board laminate to collectively form a particular shield in a confined space. By positioning the electric shields in this manner, high electric fields associated with solid state transformer applications may be concentrated within planes of the electric shields and diverted away from potential problem areas of the insulation material, for example areas close to the windings where voids in the insulation material may be more common. Additionally, electric shields may also provide planar surfaces between the primary and secondary windings that facilitate reduced voiding in areas of the insulation material that experience the high electric fields. In certain applications, this allows use of higher viscosity insulation materials within the transformer.

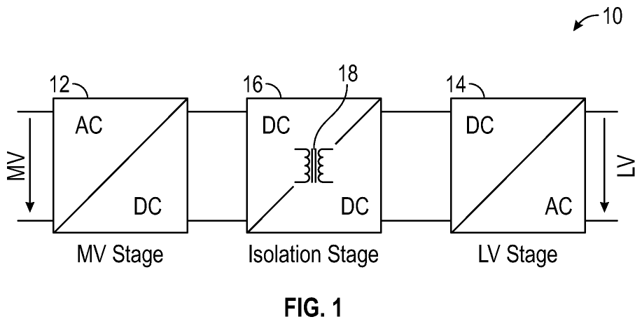

FIG. 1 is a functional schematic diagram of a solid state transformer 10 according to aspects disclosed herein. In FIG. 1, the solid state transformer 10 is illustrated as a three stage transformer device that includes a first voltage stage 12, a second voltage stage 14, and an isolation stage 16 therebetween. By way of example, the solid state transformer 10 may be configured to receive an MV input from a power grid and provide an LV output to a load. In this regard, the first voltage stage 12 may embody an MV stage that provides AC-to-DC conversion and the second voltage stage 14 may embody an LV stage that provides DC-to-AC conversion. The isolation stage 16 includes a transformer 18 that comprises a primary winding configured as an MV or primary winding and a secondary winding configured as a LV or secondary winding. In such a configuration, the transformer 18 may be referred to as an MV transformer. It is understood that solid state transformers as disclosed herein may embody other configurations, including single stage transformers where the transformer 18 may reside within an AC-to-AC stage, and dual stage transformers where the transformer 18 may reside within an AC-to-DC or DC-to-AC stage without deviating from the principles disclosed herein. Additionally, the MV and LV designations for the primary and secondary windings may be different or reversed depending on the particular step-up or step-down voltage application. In certain aspects, one or more wide band gap switching devices, for example SiC metal-oxide-semiconductor field-effect transistors (MOSFETs), SiC insulated gate bipolar transistors (IGBTs), or GaN-based switching devices may be utilized as part of circuitry that forms one or more of the first voltage stage 12, the second voltage stage 14, and the isolation stage 16 to provide increased switching frequencies, higher power handling and efficiencies with reduced device complexity compared with conventional switching devices. According to aspects disclosed herein, the solid state transformer 10 may be configured for high power operation, for example a 485 kilovolt-ampere (kVa) rated solid state transformer. While wide band gap switching devices may provide improved operating characteristics, the principles of the present disclosure may also be applicable to other devices, for example silicon-based field-effect transistors (FETs), silicon-based IGBTs, and silicon controlled rectifiers (SCRs).

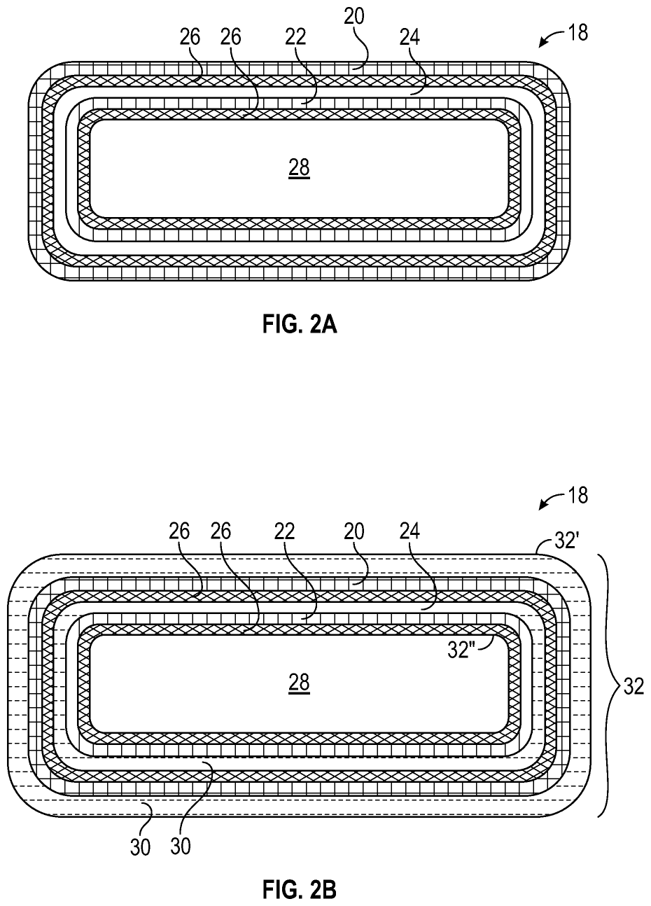

FIG. 2A is a side cross-sectional view illustrating a winding arrangement for the transformer 18 according to aspects of the present disclosure. The transformer 18 includes a primary winding 20 arranged concentrically about a secondary winding 22. For examples where the transformer 18 is an MV transformer as described for FIG. 1, the primary winding 20 may embody an MV winding that is electrically connected to an MV stage, and the secondary winding 22 may embody an LV winding that is electrically connected to an LV stage. Depending on the application, one or more of the primary winding 20 and the secondary winding 22 may include a single winding or coil or a plurality of layered windings or coils. The primary winding 20 and secondary winding 22 are arranged to form a gap 24 or spacing therebetween for isolation. In certain embodiments, the transformer 18 includes one or more coil formers 26, or bobbins, that support and form the arrangement of the windings 20, 22, provide termination and electrical connections for the windings 20, 22, and form an opening 28 that is centrally located for receiving a magnetic core (not shown) of the transformer 18.

FIG. 2B is a side cross-sectional view of the winding arrangement for the transformer 18 of FIG. 2B with an insulation material 30 added to encapsulate the primary and secondary windings 20, 22. As previously described, MV transformers for solid state transformer applications typically require insulation material 30 that is capable of handling high voltages to be arranged between the primary and secondary windings 20, 22, or within the gap 24. The insulation material 30 may comprise a potting material, for example epoxy resin or certain silicones. The insulation material 30 may be provided by a potting process where the insulation material 30 is allowed to flow into the gap 24 and to surround or encapsulate the windings 20, 22 before hardening. In certain embodiments, the potting process may comprise a molding process (e.g., epoxy molding) at atmospheric pressure or vacuum pressure potting. The resulting structure of the windings 20, 22, the coil former 26, and the insulation material 30 may be referred to as a winding package 32. An exterior wall 32′ of the winding package 32 may be formed by molded insulation material 30 or by another pre-formed structure similar to the coil former 26 that encloses the windings 20, 22 and contains flow of the insulation material 30. An interior wall 32″ of the winding package 32 that may also define the opening 28 may be formed by the innermost portion of the coil former 26. In other embodiments, the interior wall 32″ may be formed by molded insulation material 30 or by another pre-formed structure similar to the coil former 26.

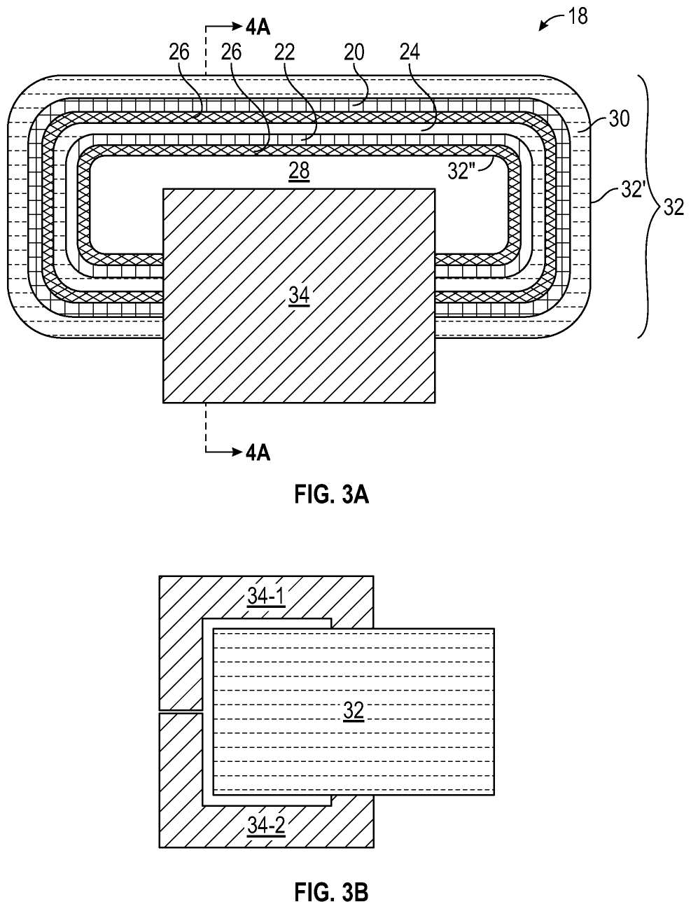

FIG. 3A is a side view of the transformer 18 illustrating an arrangement of the winding package 32 relative to a core 34. For illustrative purposes, the winding package 32 is shown in cross-section to illustrate the windings 20, 22, the coil former 26, and the insulation material 30. The core 34, or magnetic core, may comprise any number of materials, including metals, powdered metals, and ceramics. For high frequency and high power density applications for example solid state transformers, the core 34 may comprise ferrite or ferrite ceramic materials with high magnetic permeability and low electrical conductivity that provide low losses at such frequencies. Depending on the application, the core 34 may form any number of shapes, for example a U-shaped, C-shaped, or E-shaped cores, among others. FIG. 3B is an end view of the transformer 18 of FIG. 3A illustrating an embodiment where core portions 34-1, 34-2 are provided with a U-shape, a portion of which is arranged within the opening (28 of FIG. 3A) of the winding package 32. In FIG. 3B, the winding package 32 is not illustrated in cross-section as in FIG. 3A and the orientation of the view provided in FIG. 3B is taken from a right side of the image of FIG. 3A.

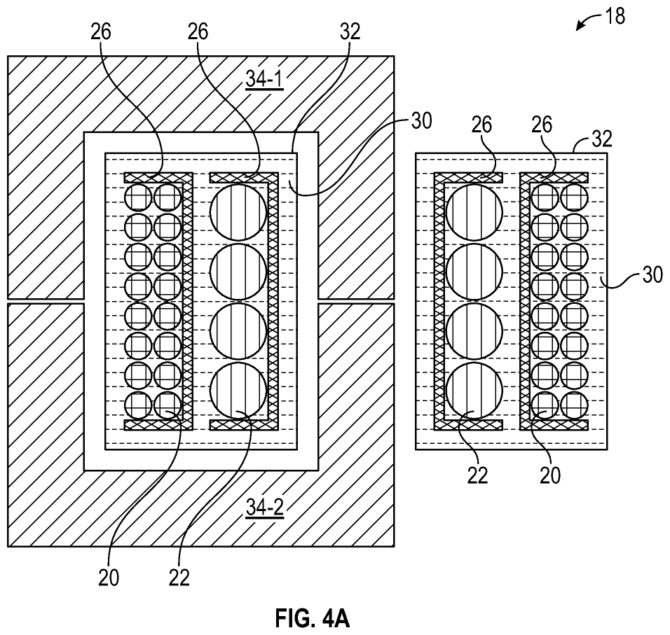

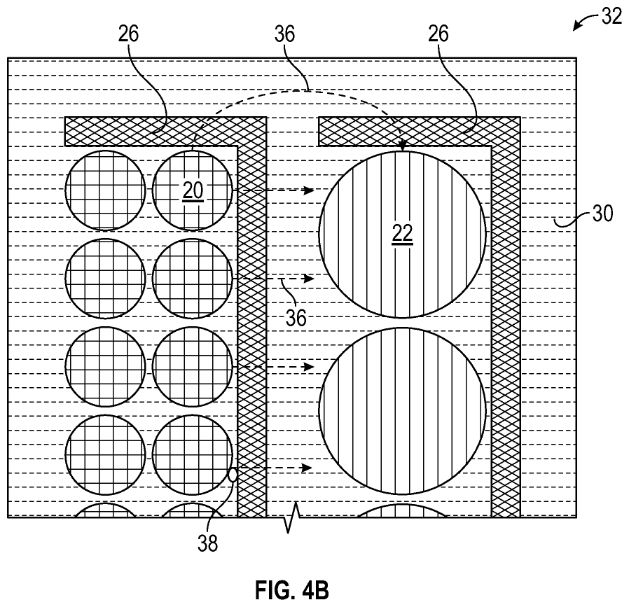

FIG. 4A is a cross-sectional view of the transformer 18 of FIG. 3A taken along the sectional line 4A-4A of FIG. 3A. As illustrated, a portion of the winding package 32 resides within the cores 34-1, 34-2 and another portion of the winding package resides outside the cores 34-1, 34-2. FIG. 4A illustrates additional details of the coil former 26 and the primary and secondary windings 20, 22. In certain embodiments, the coil former 26 may form one or more cup shapes or recesses to serve as a platform for separately retaining the windings 20, 22 in a spaced apart manner. The coil former 26 may be formed as a single piece or a multiple piece structure. For high frequency applications, the windings 20, 22 may comprise multiple-strand wires of copper or the like, for example litz wires, that are wound about the coil former 26. By way of example, the primary winding 20 is illustrated as a smaller diameter litz wire wrapped in a two layer coil structure, and the secondary winding 22 is illustrated as a larger diameter litz wire wrapped in a single layer structure. Depending on the voltage application, the number layers and/or the wire diameters may vary. In certain applications the windings 20, 22 may comprise single wires. For multiple-strand and single strand wires, the windings 20, 22 may also comprise wire insulation.

FIG. 4B is an expanded view of a portion of the winding package 32 of FIG. 4A with superimposed arrows indicating distribution of an electric field 36 within the winding package 32 during operation. As illustrated, the electric field 36 is formed between the primary winding 20 and the secondary winding 22 such that the electric field 36 traverses the insulation material 30 and portions of the coil former 26 within the winding package 32. During formation of the insulation material 30, it can be difficult to ensure complete filling and encapsulation around the windings 20, 22, particularly in areas between the one of the windings 20, 22 and corresponding portions of the coil former 26. Small voids 38 may form within the insulation material 30 that can disrupt the electric field 36 and result in higher dielectric losses, electrical discharge including partial discharge or corona, and even catastrophic device failure. While a single small void 38 is illustrated between a portion of the primary winding 20 and the coil former 26, multiple voids 38 of various sizes and shapes may be distributed in any location of the insulation material 30.

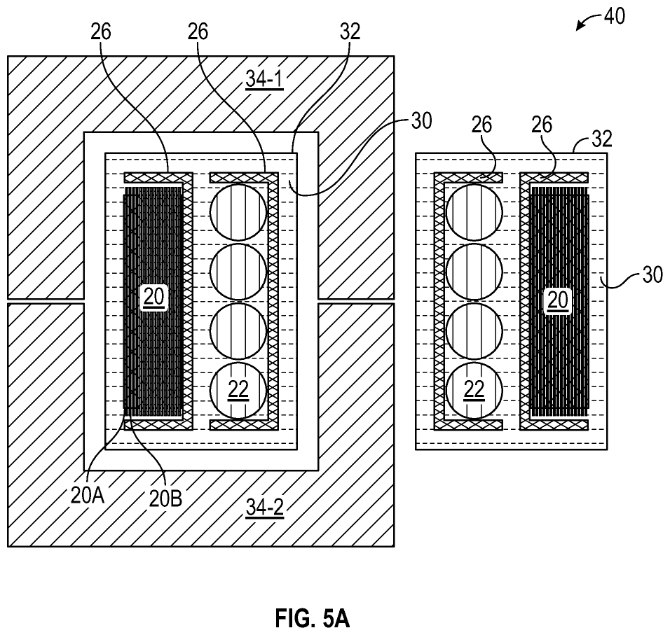

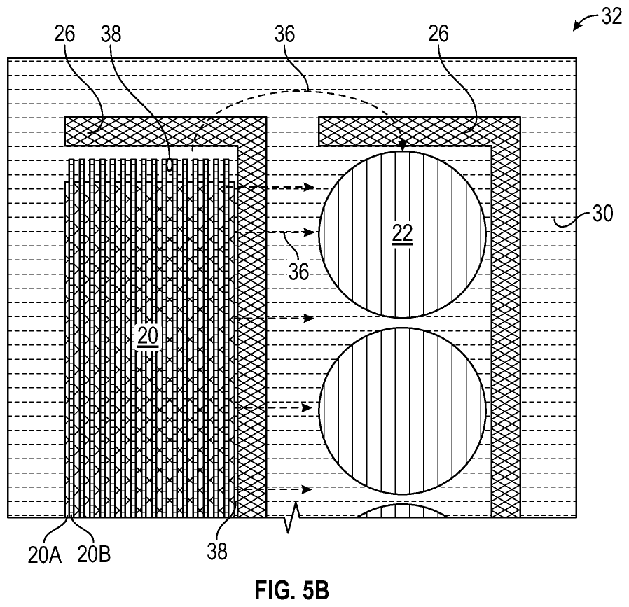

The problems associated with formation of voids 38 in the insulation material 30 is not just limited to transformers with multiple-strand wire arrangements. FIG. 5A is a cross-sectional view of a transformer 40 that is similar to the transformer 18 of FIG. 4A, but where the primary winding 20 comprises a foil structure. The foil structure of the primary winding 20 may include a laminated structure of alternating metal thin films and insulating thin films. In various configurations, the secondary winding 22 may comprise a foil structure and the primary winding 20 may comprise a multiple-strand wire (e.g., litz wire) or both the primary and secondary windings 20, 22 may comprise a foil structure. FIG. 5B is an expanded view of a portion of the winding package 32 of FIG. 5A with superimposed dashed arrows indicating distribution of the electric field 36 within the winding package 32 during operation. In FIG. 5B, the laminated structure of alternating metal thin films 20A (or foil layers) and insulating thin films 20B is more visible within the foil structure of the primary winding 20. As illustrated, the electric field 36 may form between the primary winding 20 and the secondary winding 22, traversing through portions of the insulation material 30 and the coil former 26. As with the example of FIG. 4B, one or more voids 38 can form within the insulation material 30, particularly in areas between the coil former 26 and a corresponding one of the windings 20, 22 that can disrupt the electric field 36 and result in one or more of higher dielectric losses, electrical discharge including partial discharge or corona, and catastrophic device failure as previously described. By way of example, FIG. 5B illustrates voids 38 that may form between the primary winding 20 and a lengthwise portion of the coil former 26 or along portions of the foil structure of the primary winding 20.

According to aspects disclosed herein, transformers may include one or more electric shields provided within portions of a winding package that shield and/or redirect high strength electric fields away from areas of the insulation material that may be prone to formation of voids, thereby reducing failure mechanisms associated with electrical field distribution in such areas. The electric shields may be positioned between primary and secondary windings along one or more planes that are coupled with electric potentials of the primary and secondary windings. In certain embodiments, one or more portions of the electric shields form planar structures that at least partially or fully reside within insulation material between the primary and secondary windings.

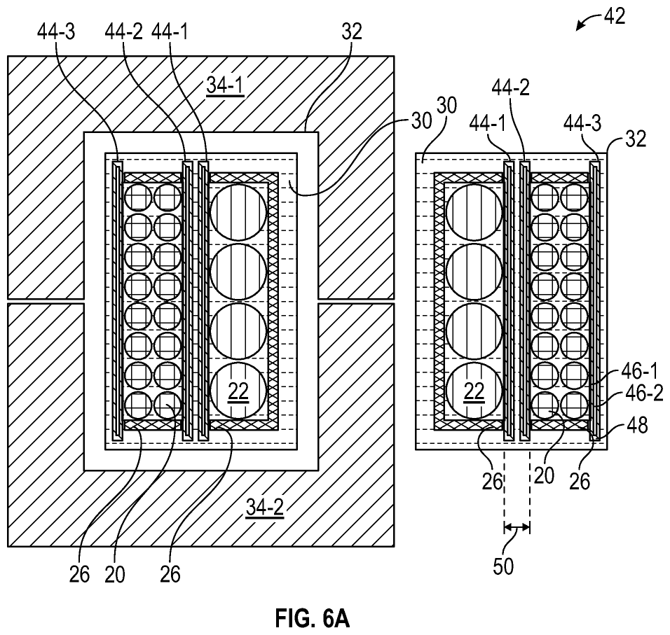

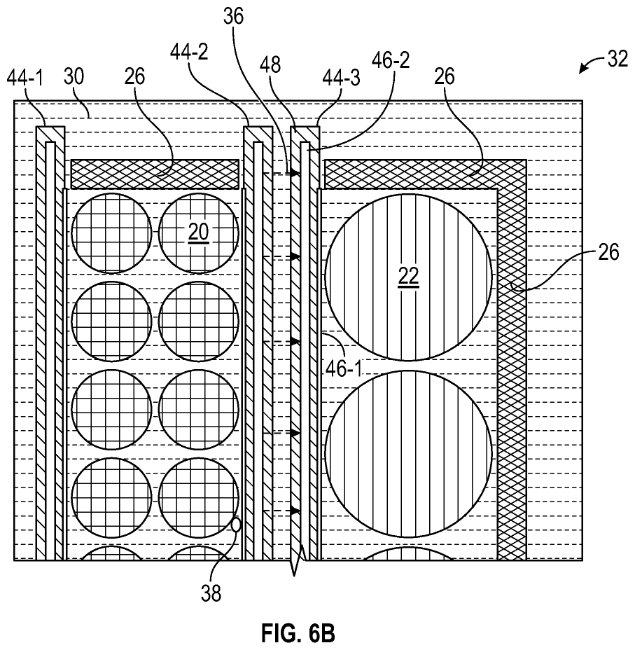

FIG. 6A is a cross-sectional view of a transformer 42 that is similar to the transformer 40 of FIG. 4A, and further includes one or more electric shields 44-1 to 44-3 arranged within the winding package 32 to alter electric field distribution during operation. Each electric shield 44-1 to 44-3 may comprise one or more metal layers 46-1, 46-2 on or within a dielectric material 48. For example, the electric shields 44-1 to 44-3 may embody printed circuit boards and the metal layers 46-1, 46-2 may comprise metal planes such as copper or the like that are laminated with the dielectric material 48. One or more electrical vias may electrically interconnect the metal layers 46-1, 46-2 within the dielectric material 48. In certain embodiments, the metal layer 46-1 may comprise a plane of metal positioned at a surface of the electric shield 44-3, and the metal layer 46-2 may comprise a plane of metal positioned within an interior of the electric shield 44-3. In other embodiments, the electric shields 44-1 to 44-3 may comprise a single metal layer (46-1 or 46-2) on an exterior surface of the dielectric material 48 or embedded within an interior of the dielectric material 48. The dielectric material 48 may embody a rigid board or support structure that is configured to support the one or more metal layers 46-1, 46-2

Each electric shield 44-1 to 44-3 is positioned proximate to a respective one of the primary winding 20 or the secondary winding 22 so that at least one of the one or more metal layers 46-1, 46-2 is coupled with the electric potential of the particular winding 20, 22. For example, the electric shield 44-1 is coupled with the electric potential of the secondary winding 22 and the electric shields 44-2, 44-3 are coupled with the electric potential of the primary winding 20. In this regard, the electric field distribution between the primary and secondary windings 20, 22 may be tailored to avoid areas of the insulation material 30 where voids are likely to form. In each of the primary and secondary windings 20, 22, each winding turn (represented as the circles in FIG. 6A) may have a different electric potential. In this manner, the electric shields 44-1 to 44-3 may be coupled with average electric potentials of corresponding windings 20, 22. In certain embodiments, a single winding turn of the windings 20, 22 may be arranged to directly contact the metal layer 46-1 of a corresponding shield while the other winding turns of each winding 20, 22 may be spaced from the metal layer 46-1 by portions of the insulation material 30. In certain embodiments, the metal layers 46-1, 46-2 may form full or continuous planes of metal that entirely extend within the insulation material 30 and between the windings 20, 22. In other embodiments, the metal layers 46-1, 46-2 may form other patterns that are tailored to distribute the electric field away from certain areas of the insulation material 30. In one example, the metal layers 46-1, 46-2 may be arranged to cover different areas within the electric shields 44-1 to 44-3. In FIG. 6A, the metal layer 46-1 is arranged closest to particular ones of the windings 20, 22. In this manner, the metal layer 46-1 is positioned to extend lengthwise a distance that is at least the same as a length or longest dimension of the corresponding winding 20, 22. In FIG. 6A, this distance may correspond with a distance between end portions of the coil former 26 that are on opposing ends (e.g., top and bottom in the view of FIG. 6A) of each of the windings 20, 22. The metal layer 46-2 may extend in a same lengthwise direction a greater distance such that the metal layer 46-2 extends past boundaries defined by the coil former 26. In this manner, the metal layers 46-1, 46-2 may alter different areas the electric field during operation.

In certain embodiments, the primary and secondary windings 20, 22 may be wrapped around the electric shields 44-1 to 44-3 before potting with the insulation material 30. In this manner, the electric shields 44-1 to 44-3 may be configured to replace portions of the coil former 26 that would otherwise extend lengthwise across the windings 20, 22. In certain embodiments, the coil former 26 includes one or more slots 50 or openings formed in opposing end portions of the coil former 26 for positioning of the electric shields 44-1 to 44-3. In the orientation of the view of FIG. 6A, the end portions of the coil former 26 correspond with top and bottom portions on opposing top and bottom ends of the windings 20, 22. The primary and secondary windings 20, 22 may then be coiled around the electric shields 44-1 to 44-3 and the other portions of the coil former 26 before potting. In this regard, the combination of the electric shields 44-1 to 44-3 and the coil former 26 may form a hybrid coil former. In other embodiments, the coil former 26 may be configured in a similar manner as in FIG. 4A and the electric shields 44-1 to 44-3 may be positioned between the coil former 26 and respective ones of the windings 20, 22. The coil former 26 may include additional openings or channels to allow flow of the insulation material 30 during encapsulation.

FIG. 6B is an expanded view of a portion of the winding package 32 of FIG. 6A with superimposed dashed arrows indicating distribution of the electric field 36 within the winding package 32 during operation. During operation, the electric filed 36 is strongest in areas that are directly between the primary and secondary windings 20, 22. By connecting the metal layers 46-1, 46-2 of a particular electric shield 44-1 to 44-3 to the electric potential of a corresponding winding 20, 22, the electric field 36 may be confined or concentrated in the electric shields 44-1 to 44-3 and away from areas of the insulation material 30 that are prone to void formation, for example areas that are proximate the primary winding 20. As illustrated in FIG. 6B, one or more of the voids 38 may be formed in such an area in a similar manner as FIG. 4B, however the presence of the electric shield 44-2 reduces interaction between the void 38 and the electric field 36, thereby limiting failure mechanisms such as increased dielectric losses, partial discharges and corona events, and catastrophic device failure. Instead, the electric field 36 between the windings 20, 22 may accordingly be distributed between the electric shields 44-2 and 44-3. Additionally, the presence of the electric shields 44-2, 44-3 may reduce void formation in portions of the insulation material 30 between the windings 20, 22 where the electric field 36 is present. For example, the electric shields 44-2 and 44-3 may provide smoother and more even surfaces for flow of the insulation material 30 during encapsulation so that the insulation material 30 may more evenly fill the space between the electric shields 44-2 and 44-3 where the electric field 36 is present during operation. This may also allow the insulation material 30 to comprise a higher viscosity material, depending on the application. For example, conventional devices may utilize an insulation material having a viscosity of about 1900 centipoise (cP) while the present disclosure allows the insulation material 30 to comprise viscosity values greater than 1900 cP while still providing adequate fill during encapsulation. In one example, the insulation material 30 comprises a viscosity in a range from 2500 cP to 5000 cP, or in a range from 2700 cP to 4000 cP, or in a range from 3000 cP to 4000 cP, or in any range formed by endpoints of any of the foregoing values. In particular applications, the ability to select higher viscosity values for the insulation material 30 may also allow selection of materials with other desirable characteristics for the insulation material 30. For example, some higher viscosity materials may also have higher thermal conductivities. In one example, a material having a viscosity of about 3100 cP for the insulation material 30 may also provide a thermal conductivity value that is from two to three times higher than a conventional material with a viscosity value of about 1900 cP. While the embodiments illustrated in FIGS. 6A and 6B provide arrangements of electric shields 44-1 to 44-3 with wire-based winding structures (e.g., litz wiring or the like), one or more of the primary and secondary windings 20, 22 may comprise a foil structure as previously described for FIGS. 5A and 5B without deviating from the principles described herein.

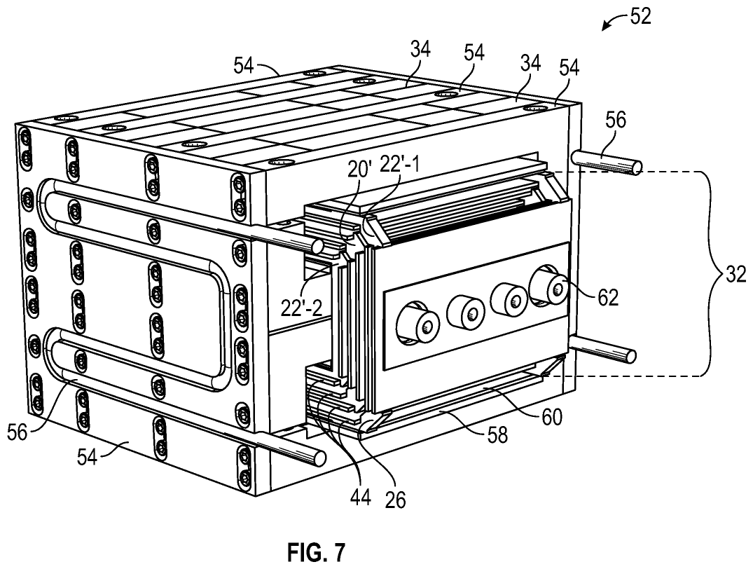

FIG. 7 is a perspective view of a model of a transformer 52 according to aspects of the present disclosure. The transformer 52 may be configured in a similar manner as described for the transformer 42 of FIGS. 6A and 6B. For illustrative purposes, the winding package 32 is shown without the insulation material 30 and the windings 20, 22 to illustrate the arrangement of electric shields 44 and the coil former 26. Multiple cores 34 are arranged along lengthwise portions of the winding package 32, and one or more housing plates 54 may be arranged to secure the cores 34 relative to the winding package 32. The housing plates 54 may comprise a material of high thermal conductivity, for example aluminum or alloys thereof, for heat dissipation within the transformer 52. Additionally, one or more fluid conduits 56 may also be arranged along or within certain ones of the housing plates 54 for added heat dissipation. An end of the winding package 32 is illustrated as protruding from the cores 34 and the housing plates 54. Thermal layers or plates 58, 60 may be positioned between the winding package 32 and the cores 34 and the housing plates 54 to provide additional heat dissipation. In certain embodiments, the thermal layers or plates 58, 60 comprise one or more combinations of high thermally conductive materials, for example metal plates and ceramic layers or plates. By way of example, the thermal layer 58 may embody an aluminum plate and the thermal layer 60 may embody a ceramic layer or plate. One or more electrical connections 62 for the windings (20, 22 of FIG. 6A) may be provided at one or more ends of the winding package 32.

As illustrated by the end of the winding package 32 that is visible in FIG. 7, the coil former 26 may form end caps that support the electric shields 44. The electric shields 44 may extend through slots or openings of the coil former 26 and the positions of the windings (20, 22 of FIG. 6A) may formed by a combination of the coil former 26 and the electric shields 44 in a similar manner as illustrated in FIG. 6A. The transformer 52 of FIG. 7 is arranged for a winding configuration that includes a primary winding and two halves of a secondary winding on opposing sides of the primary winding. In FIG. 7, a location of the primary winding is designated 20′ and locations of the two halves of the secondary windings are designated 22′-1, 22′-2 relative to portions of the end caps of the coil former 26. When present, the primary and secondary windings will traverse between these respective locations 20′, 22′-1, 22′-2 above and below respective ones of the electric shields 44. As constructed, the transformer 52 may be suited for sufficiently handling high frequency and high temperature operating conditions that may be present in solid state transformer devices.

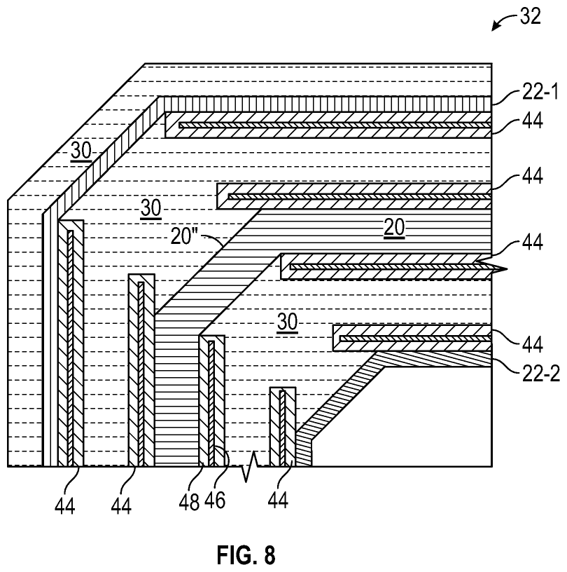

FIG. 8 is an expanded cross-sectional view of a corner of the winding package 32 of FIG. 7 illustrating an arrangement of the primary winding 20 and a plurality of secondary windings 22-1, 22-2 relative to the electric shields 44. While the electric shields 44 are illustrated with a single metal layer 46 within a dielectric material 48, the electric shields 44 may include a plurality of metal layers 46 formed in a laminate structure as previously described. In certain embodiments, the primary winding 20 is centrally located within the winding package 32 in between and in a spaced apart manner from the two halves of the secondary winding 22-1, 22-2. The electric shields 44 at least partially define channels where the windings 20, 22-1, 22-2 reside. As illustrated, one or more of the electric shields 44 may be configured to extend in a linear manner past corner winding turns of different ones of the windings 20, 22-1, 22-2 to provide extended electric field shielding at corners or turns of the windings 20, 22-1, 22-2. For example, the corresponding electric shields 44 that are arranged between the primary winding 20 and the secondary winding 22-1 extend past a corner turn 20″ or winding turn of the primary winding 20. In this manner, the electric field in operation may be sufficiently spaced from the corner turn 20″ of the primary winding 20 without the electric shields 44 having to completely contact each other at the corner turn 20″. While the plurality of secondary windings 22-1, 22-2 are illustrated in FIG. 8, the aspects disclosed are also applicable to other winding arrangements, for example those with a single primary winding and a single secondary winding. In various configurations, one or more of the primary and secondary windings 20, 22 may comprise a foil structure as previously described for FIGS. 5A and 5B without deviating from the principles described herein.

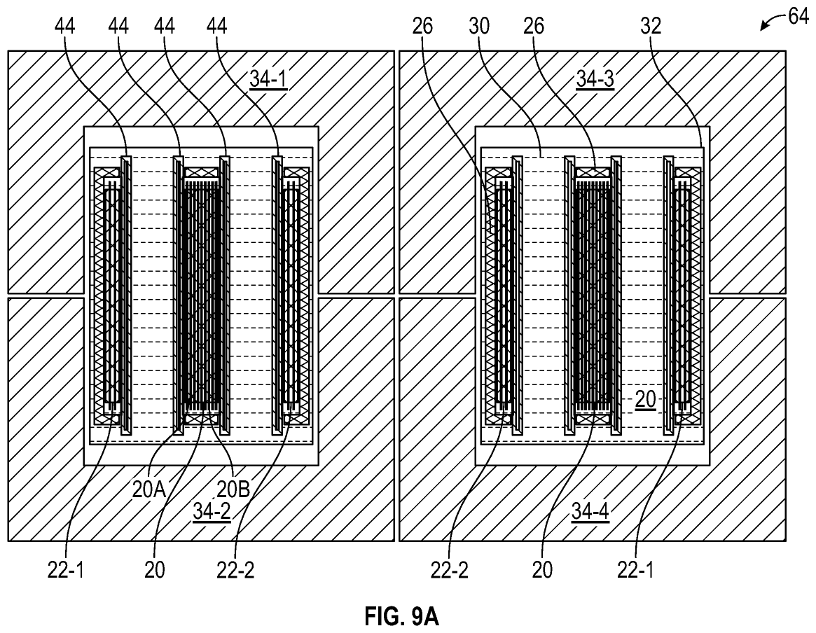

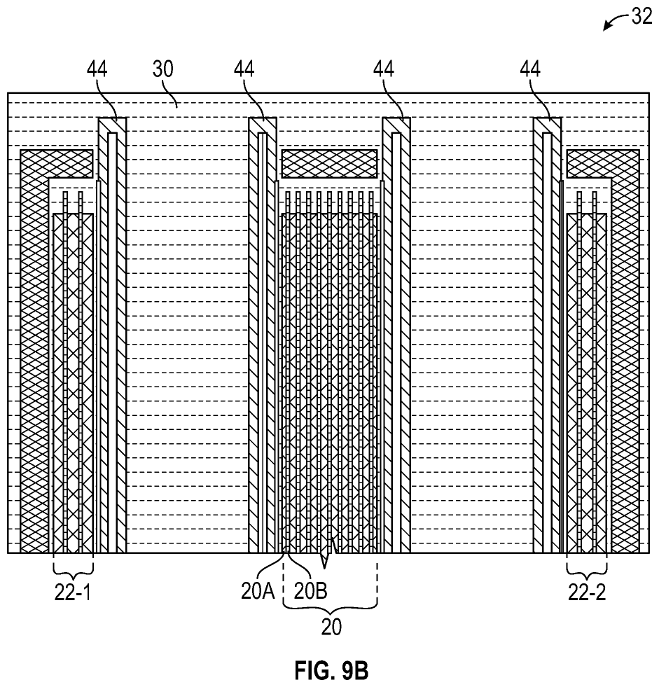

FIG. 9A is a cross-sectional view of a transformer 64 that is similar to the transformer 42 of FIG. 6A, except the secondary winding 22-1, 22-2 is configured with two halves on opposing sides of the primary winding 20. Additionally, the primary and secondary windings 20, 22-1, 22-2 embody foil structures as previously described for FIGS. 5A and 5B. As with other embodiments, one or more of primary and secondary windings 20, 22-1, 22-2 may also embody wire structures or multiple-strand wire structures including litz wiring. As illustrated, the two halves of the secondary winding 22-1, 22-2 are positioned in a spaced apart manner on opposing sides of the primary winding 20 within the winding package 32. Additionally, cores 34-1 to 34-4 are respectively positioned along opposing ends of the winding package 32 in a manner similar to the transformer 52 of FIG. 7.

FIG. 9B is an expanded view of a portion of the winding package 32 of FIG. 9A. As illustrated, the insulation material 30 may fill and encapsulate portions of the winding package 32 on opposing sides of the primary winding 20 where the electric field is expected to be highest in operation. As previously described, the electric shields 44 may define the spaces between the primary winding 20 and the secondary winding 22-1, 22-2 with surfaces that promote encapsulation with reduced voiding. Additionally, the electric shields 44 may further distribute the electric field away from areas of the insulation that are between individual electric shields 44 and corresponding windings 20, 22-1, 22-2 where voiding may be more likely to occur.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A transformer comprising:
a primary winding;
a secondary winding;
an insulation material arranged between the primary winding and the secondary winding; and
at least one electric shield positioned at least partially within the insulation material and between the primary winding and the secondary winding.

2. The transformer of claim 1, wherein the at least one electric shield comprises at least one metal layer and at least one dielectric material, the at least one metal layer residing on the at least one dielectric material or within the at least one dielectric material.

3. The transformer of claim 2, wherein the at least one metal layer comprises a plurality of metal layers, a first metal layer of the plurality of metal layers is on the at least one dielectric material, and a second metal layer of the plurality of metal layers is within the at least one dielectric material.

4. The transformer of claim 3, wherein the first metal layer is arranged closer to one of the primary winding or the secondary winding than the second metal layer, the first metal layer being arranged to extend a distance that corresponds to at least a longest dimension of the primary winding or the secondary winding, and the second metal layer is arranged to extend a distance that is greater than the first metal layer.

5. The transformer of claim 1, wherein the at least one electric shield comprises a printed circuit board.

6. The transformer of claim 1, wherein the at least one electric shield comprises a first electric shield that is coupled with an electric potential of the primary winding and a second electric shield that is coupled with an electric potential of the secondary winding.

7. The transformer of claim 1, wherein the at least one electric shield is completely encapsulated within the insulation material.

8. The transformer of claim 1, further comprising a coil former that at least partially defines a shape of at least one of the primary winding and the secondary winding.

9. The transformer of claim 8, wherein the coil former and the at least one electric shield define the shape of at least one of the primary winding and the secondary winding.

10. The transformer of claim 8, wherein the coil former forms at least one opening that supports at least a portion of the at least one electric shield.

11. The transformer of claim 1, further comprising a magnetic core, wherein the insulation material, the primary winding, the secondary winding, and the at least one electric shield form a winding package, the winding package forming a central opening, and a portion of the magnetic core resides within the central opening.

12. The transformer of claim 11, wherein the primary winding forms a winding turn along a corner of the winding package and the at least one electric shield extends past the winding turn.

13. The transformer of claim 11, further comprising at least one thermal plate arranged between the winding package and the magnetic core.

14. The transformer of claim 1, wherein the primary winding is configured as a medium voltage winding and the secondary winding is configured as a low voltage winding.

15. The transformer of claim 1, wherein at least one of the primary winding and the secondary winding comprises multiple-strand wiring.

16. The transformer of claim 1, wherein at least one of the primary winding and the secondary winding comprises a foil structure.

17. The transformer of claim 1, wherein the insulation material comprises a viscosity in a range from 2500 centipoise (cP) to 5000 cP.

18. A solid state transformer comprising:
a first voltage stage;
a second voltage state; and
an isolation stage arranged between the first voltage stage and the second voltage stage, the isolation stage comprising:
a transformer comprising a primary winding, a secondary winding, an insulation material arranged between the primary winding and the secondary winding, and at least one electric shield positioned between the primary winding and the secondary winding.

19. The solid state transformer of claim 18, wherein the at least one electric shield is encapsulated within the insulation material.

20. The solid state transformer of claim 18, wherein the at least one electric shield comprises a printed circuit board.

21. The solid state transformer of claim 18, wherein at least one of the first voltage stage and the second voltage stage comprises a wide band gap switching device.

22. The solid state transformer of claim 21, wherein the wide band gap switching device comprises a silicon carbide switching device.

23. The solid state transformer of claim 18, wherein the isolation stage comprises a wide band gap switching device.

24. The solid state transformer of claim 23, wherein the wide band gap switching device comprises a silicon carbide switching device.

25. The solid state transformer of claim 18, wherein the first voltage stage comprises a medium voltage stage electrically connected to the primary winding, and the second voltage stage comprises a low voltage stage electrically coupled to the secondary winding.

26. The solid state transformer of claim 18, wherein the solid state transformer is rated for operation up to 485 kilovolt-amperes.

27. The solid state transformer of claim 18, wherein the insulation material comprises a viscosity in a range from 2500 centipoise (cP) to 5000 cP.
